(19) United States
(12) Patent Application Publication
(10) Pub. No.: US 2009/0150050 A1
(43) Pub. Date: Jun. 11, 2009

(54) FUEL INJECTOR AND FUEL INJECTION DEVICE HAVING SAME

(75) Inventors: Makoto Mashida, Kariya-city (JP); Masaaki Kato, Kariya-city (JP); Kenji Funal, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/325,399

(22) Filed: Dec. 1, 2008

(30) Foreign Application Priority Data
Dec. 5, 2007 (JP) 2007-314267

(51) Int. Cl. F02D 41/30

(52) U.S. Cl. 701/103; 251/12

(57) ABSTRACT

A fuel injector is configured to inject gaseous fuel into a combustion chamber of an engine by using liquid fuel as a pressure transmission medium to open and close a nozzle hole. A nozzle portion has a fuel chamber and a tip end, which defines the nozzle hole. A first passage is configured to communicate the fuel chamber with a gaseous fuel passage to introduce gaseous fuel. A second passage is configured to communicate the fuel chamber with a liquid fuel passage to introduce liquid fuel. A passage switching valve is configured to switch the first passage and the second passage.

### CROSS REFERENCE TO RELATED APPLICATIONS

This application is based on and incorporates herein by reference Japanese Patent Application No. 2007-314267 filed on Dec. 5, 2007.

### FIELD OF THE INVENTION

The present invention relates to a fuel injector for injecting gaseous fuel into a cylinder in an internal combustion engine. The present invention further relates to a fuel injection device having the fuel injector.

### BACKGROUND OF THE INVENTION

In development of a next-generation automobile, greater importance is given to reduction in environmentally hazardous substances (NOx, CO₂, PM or the like) in combustion exhaust gases, but the combustion dependent on the conventional fossil liquid fuel has a limitation to the reduction. Therefore, as alternative fuel to the fossil liquid fuel, development of a gaseous fuel engine using gaseous fuel such as natural gas (LNG and CNG), petroleum gas (LPG) or hydrogen gas, which is expected to have a higher combustion efficiency, is in progress. The gaseous fuel has a low heat release value per volume, that is, the gaseous fuel is low in energy density. Therefore, a vehicle with the conventional gaseous fuel engine requires high-pressure accumulation or large sizing of a fuel storage tank for increasing a quantity of the gaseous fuel mounted to the vehicle. However, the fuel storage tank, which can be actually mounted in a commercial vehicle, has a limitation with respect to the high-pressure accumulation or the large sizing. In addition, infrastructure of a station for gaseous fuel supply is still insufficient in so far. Therefore, it is more difficult for the gaseous fuel engine to secure a sufficient travel distance as compared to a liquid fuel engine such as gasoline or light oil engine.

On the other hand, for further reduction in combustion exhaust emissions even in an engine using the conventional fossil fuel, a gasoline engine has difficulties in improving of a fuel economy compared to that of a diesel engine. By contrast, a diesel engine has difficulties in improving of exhaust purification compared with that of the gasoline engine. Under such a circumstance, homogeneous charge compression ignition (HCCI) has been focused as a technology for achieving advantages of both of the gasoline engine and the diesel engine. An HCCI engine has a structure in which a pre-mixture of air and fuel is introduced into a combustion chamber, and a high temperature and a high pressure are generated in a combustion chamber through compression of the pre-mixture by a piston, thereby performing self-ignition of the pre-mixture at multi-points simultaneously. However, since the ignition in the HCCI engine depends on an ignition temperature specific to the fuel, it is difficult to control the ignition timing. In consequence, knocking tends to easily occur in a high-load region, and sufficient mixing of air and fuel is not performed due to lack of the mixing time in a high-rotation-speed region. Therefore, an operation region of the HCCI engine is limited to a low-load region and a low-rotation-speed region.

JP-A-2003-232234 discloses the injection technology using two kinds of fuel in which a liquefied petroleum gas and liquid fuel or gaseous fuel are selectively or simultaneously supplied in accordance with an engine operating condition. This technology is provided with a high-pressure gaseous fuel supply system for supplying a liquefied petroleum gas and a high-pressure liquid fuel supply system for supplying liquid fuel or gaseous fuel. In this case, at switching to an operation using only the liquefied petroleum gas, both of the liquefied petroleum gas and the liquid fuel are supplied to an internal combustion engine to restrict occurrence of extreme leanness in an air-fuel ratio, thus restricting occurrence of misfire or deterioration of drivability.

JP-A-2006-200438 discloses the technology which includes fuel switching means for switching hydrogen fuel and gasoline as fuel supplied to an engine, switching control means for controlling the switching means based upon a preset switching condition, hydrogen fuel remaining quantity detecting means, first distance detecting means for detecting a distance within which a vehicle can travel by a hydrogen fuel remaining quantity and second distance detecting means for detecting a distance to the nearest hydrogen fuel supply deposit. In this construction, the hydrogen fuel and the gasoline are used selectively depending on the first distance and the second distance to achieve optimization of use fuel between the hydrogen fuel and the gasoline in such a manner as to restrict use frequency of the gasoline while considering the difficulty in the hydrogen fuel.

JP-A-11-351091 discloses a fuel injector for expanding a combustion region of HCCI. This fuel injector includes a fuel injection nozzle having two kinds of passages into which low-cetane number fuel and high-cetane number fuel are supplied and having two kinds of nozzle holes at a tip end thereof to be connected to the respective passages so that injection axis lines of the nozzle holes intersect immediately after outlets thereof. This fuel injector further includes means for making both of the fuel collide with each other immediately after the outlets of both the nozzle holes at combustion of HCCI to spray the fuel toward a piston away from TDC.

The technology disclosed in JP-A-2003-232234, however, requires high-pressure gaseous fuel supply means (fuel injector for high-pressure gaseous fuel) and high-pressure liquid fuel supply means (fuel injector for high-pressure liquid fuel), possibly leading to complexity, large sizing, and high-costs of the fuel injection device. In addition, it is extremely difficult to mount the fuel injector to each cylinder and therefore, as shown in JP-A-2003-232234, the multiple fuel injectors are required to be arranged in an intake manifold, estimating that it is difficult to apply this fuel injection device to a direct-injection type engine for injecting fuel directly into an engine cylinder Further, in a case where a remaining quantity of the liquefied petroleum gas is reduced, misfire may occur due to lack of the high-pressure gaseous fuel. In the technology disclosed in JP-A-2006-200438, in a case where a fuel injector for hydrogen fuel and a fuel injector for gasoline are individually provided, when one of the fuel injectors is operated by a supply fuel switching device, the other is stopped. In such a construction, the fuel injection device is sized to be large and therefore, it may be difficult to apply the device to a direct-injection type engine in which the fuel injector is mounted to each cylinder. In a case where one fuel injector serves as both of a fuel injector for hydrogen fuel and a fuel injector for gasoline, among open-close valves provided in fuel tanks respectively, one thereof is opened and the other is closed. However, a detailed structure of the fuel injector is not clear and further, such a construction requires supply fuel switching means in addition to the fuel injector. Therefore, the construction becomes complicated, possibly leading to large sizing and high costs of the device.

In the technology disclosed in JP-A-11-351091, there is provided a fuel injector which is constructed by combining a nozzle holder of a double-rod structure with a base of a double-needle valve structure including an outer needle valve and an inner needle valve. The fuel injector performs injection of low-cetane number fuel and injection of high-cetane number fuel. Therefore, the structure of the fuel injector is extremely complicated and particularly, the double-needle valve structure requires an extremely high processing accuracy, possibly leading to high costs of the fuel injector.

### SUMMARY OF THE INVENTION

The present invention addresses the above disadvantage. According to one aspect of the present invention, a fuel injector configured to inject gaseous fuel into a combustion chamber of an engine by using liquid fuel as a pressure transmission medium to open and close a nozzle hole, the fuel injector comprises a nozzle portion having a fuel chamber and a tip end, which defines the nozzle hole. The fuel injector further comprises a first passage configured to communicate the fuel chamber with a gaseous fuel passage to introduce gaseous fuel. The fuel injector further comprises a second passage configured to communicate the fuel chamber with a liquid fuel passage to introduce liquid fuel. The fuel injector further comprises a passage switching valve configured to switch the first passage and the second passage.

### BRIEF DESCRIPTION OF THE DRAWINGS

The above and other objects, features and advantages of the present invention will become more apparent from the following detailed description made with reference to the accompanying drawings. In the drawings:

FIG. 1 is a construction diagram showing an entire construction of a fuel injection device according to a first embodiment of the present invention;

FIG. 2 is a plan view showing the fuel injector according to the first embodiment;

FIG. 3 is a cross section in an arrow taken along line III, XII, XIII-III, XII, XII in FIG. 2 of the fuel injector according to the first embodiment;

FIG. 4 is a cross section in an arrow taken along line IV-IV in FIG. 2 of the fuel injector according to the first embodiment;

FIG. 5A is a schematic diagram showing a passage switching valve according to the first embodiment. FIG. 5B is a partial cross section showing a passage at a switching valve position 1, and FIG. 5C is a partial cross section showing the passage at a switching valve position 2;

FIG. 6A is a characteristic diagram showing a control state of the fuel injection device according to the first embodiment, wherein a gaseous fuel remaining quantity is greater than or equal to a predetermined value, and FIG. 6B is a characteristic diagram showing a control state of the fuel injection device according to the first embodiment, wherein a gaseous fuel remaining quantity is less than a predetermined value;

FIG. 7 is a flow chart showing a main routine in a control method of the fuel injection device according to the first embodiment;

FIG. 8 is a flow chart showing a fuel switching routine in the control method of the fuel injection device according to the first embodiment;

FIG. 9A is a diagram showing pilot injection out of injection patterns applicable to the fuel injection device according to the first embodiment, and FIG. 9B is a diagram showing HCCI injection out of the injection patterns applicable to the fuel injection device according to the first embodiment;

FIG. 10 is a flow chart showing a pilot injection routine applicable to the fuel injection device according to the first embodiment;

FIG. 11 is a flow chart showing an HCCI injection routine applicable to the fuel injection device according to the first embodiment;

FIG. 12 is a cross section in an arrow taken along line III, XII, XIII-III, XII, XIII in FIG. 2 of a fuel injector according to a second embodiment;

FIG. 13 is a cross section in an arrow taken along line III, XII, XIII-III, XII, XIII in FIG. 2 of the fuel injector according to the second embodiment;

FIG. 14A is a schematic diagram showing a passage switching valve according to the second embodiment;

FIG. 14B is a partial cross section showing a passage at the switching valve position 1; and

FIG. 14C is a partial cross section showing the passage at the switching valve position 2.

### DETAILED DESCRIPTION OF PREFERRED EMBODIMENTS

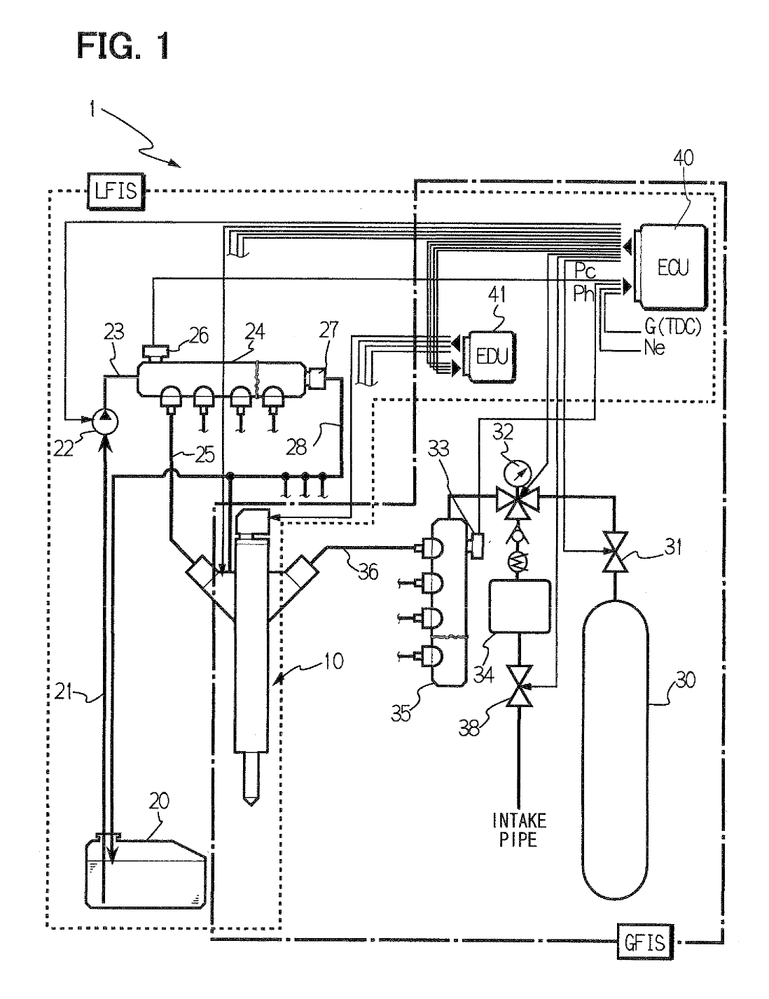

Hereinafter, an outline of a fuel, injection device 1 according to a first embodiment of the present invention will be explained with reference to FIG. 1. In the present embodiment, gaseous fuel GF such as natural gas (liquid natural gas:LNG and compressed natural gas:CNG), petroleum gas (liquefied petroleum gas:LPG) or hydrogen gas is used as high-pressure gaseous fuel. In addition, liquid fuel (LF) such as high-cetane number light oil or dimethyl ether (DME) is used as high-pressure liquid fuel. The fuel injection device 1 is provided with a single fuel injection valve 10 used in both of a gaseous fuel injection system (GFIS) for performing injection of gaseous fuel (GF) and a liquid fuel injection system (LFIS) for performing injection of liquid fuel (LF). The fuel injection valve 10 is configured as a fuel injector for a multi-cylinder internal combustion engine for injecting fuel directly into a cylinder. Each fuel injection valve 10 is provided to each cylinder.

The GFIS is constructed of a high-pressure GF tank 30, an open-close valve 31, a pressure-regulating valve 32, a purge tank 34, a relief valve 38, a GF common rail 35, a GF pressure sensor 33, a GF supply pipe 36, the fuel injection valve 10, an electronic control unit (ECU) 40, and an injector drive unit (EDU) 41. LFIS is constructed of an LF tank 20, liquid supply pipes 21 and 23, a high-pressure pump 22, an LF common rail 24, an LF supply pipe 25, an LF pressure sensor 26, a safety valve 27, an LF collection pipe 28, the fuel injection valve 10, the ECU 40, and the EDU 41. The liquid fuel LF drawn from the LF tank 20 by the high-pressure pump 22 is accumulated in the LF common rail 24 and is supplied to multiple fuel injection valves 10 The high-pressure gaseous fuel GF accumulated in the GF common rail 35 through the pressure regulating valve 32 from the high-pressure GF tank 30 is supplied to the multiple fuel injection valves 10. A part of the liquid fuel LF from the fuel injection valve 10 is recirculated through the LF collection pipe 28 to the LF tank 20.

The ECU 40 obtains an operating condition of an engine by calculating in accordance with input signals such as an engine rotational speed Ne, a crank angle (TDC), a GF pressure Ph, a liquid fuel (LF) pressure Pc, and a cooling water temperature inputted from an engine rotation detector, a G sensor a GF pressure sensor 33, an LF pressure sensor 26, a cooling water temperature sensor, and the like to transmit a drive signal of the fuel injection valve 10 to the EDU 41. The injection of the fuel injection valve 10 is controlled according to the drive current supplied from the EDU 41 to the fuel injection valve 10.

The ECU 40 performs switching-control of a flow passage switching valve 400 housed in the fuel injection valve 10 so as to appropriately select and inject fuel to be injected from the fuel injection valve 10 into the internal combustion engine from the gaseous fuel GF and the liquid fuel LF, based upon an operating state and a fuel remaining quantity. The liquid fuel LF is used not only as auxiliary fuel for improving ignitability of the gaseous fuel having a low ignitability, but also as a pressure transmission medium for transmitting a drive force of the fuel injection valve 10 and as lubricating oil.

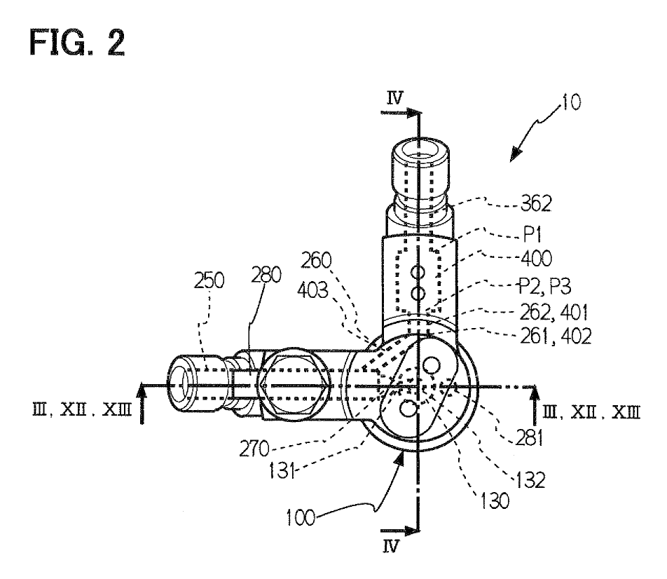

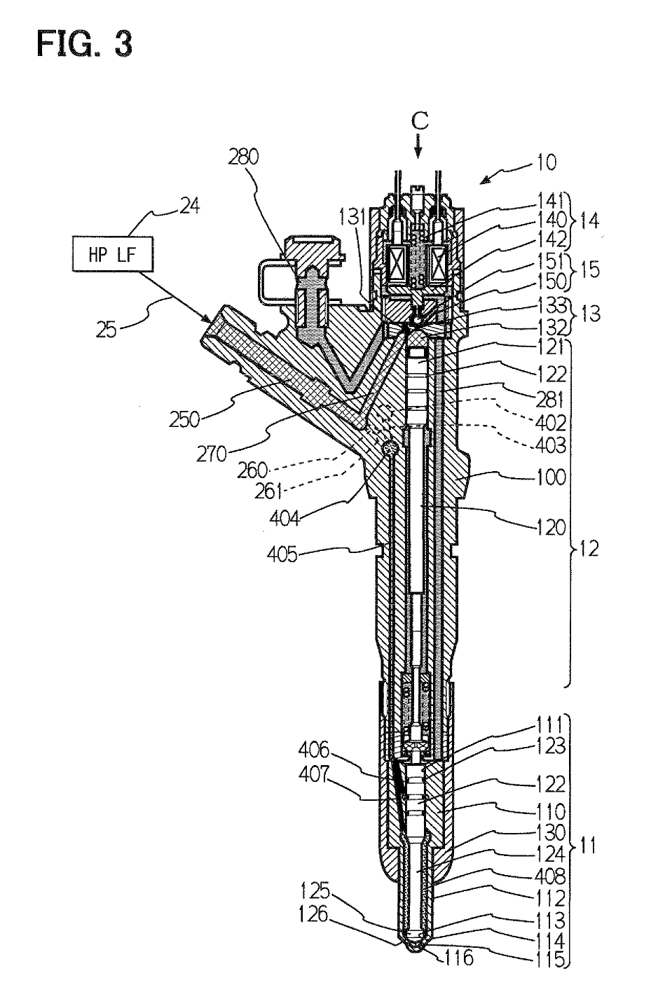

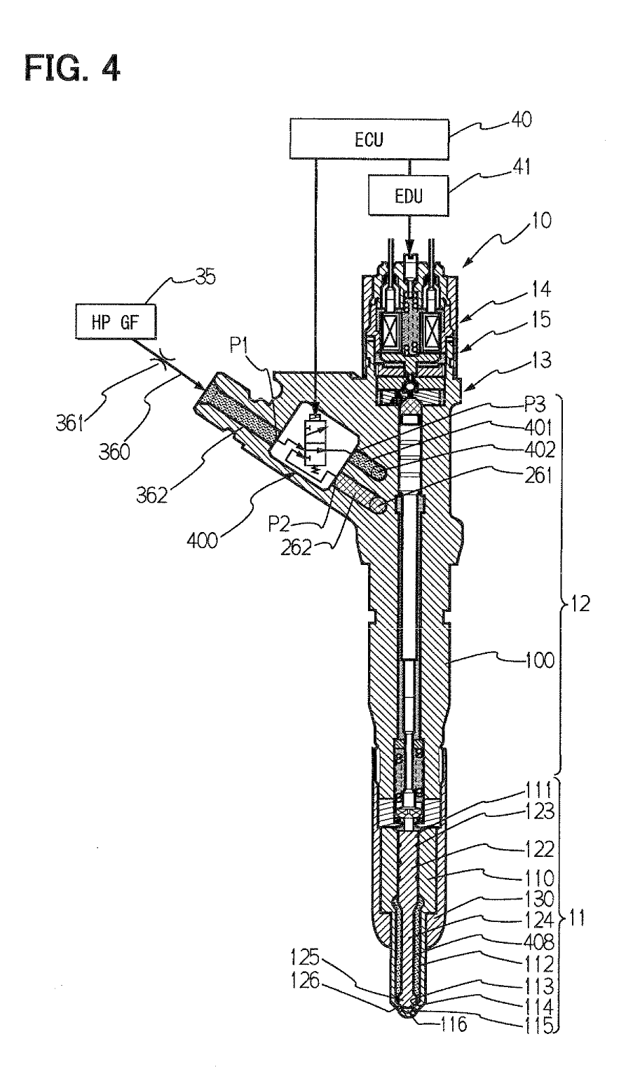

The fuel injection valve 10 will be explained in detail with reference to FIGS. 2 to 4. FIGS. 3 and 4 are longitudinal cross sections each showing an entire construction of the fuel injection valve 10 according to the present embodiment. FIG. 2 is a plan view in an arrow in FIG. 3. FIG. 3 is a cross section in an arrow taken along line III-III in FIG. 2. FIG. 4 is a cross section in an arrow taken along line VIII-VIII in FIG. 2.

First, a basic structure of the fuel injection valve 10 will be explained. The fuel injection valve 10 includes an injector base body 100 formed in a generally cylindrical shape, a nozzle portion 11 arranged in a tip side of the injector base body 100, a flow passage defining portion 12 provided with fuel flow passages 401, 402, 403, 404, 405 and the like arranged inside the injector base body 100, a control portion 13, a backpressure control valve portion 151 and an actuator 14 driving the backpressure control valve portion 15 which are provided in a base side of the injector base body 100, and the flow passage switching valve 400 which is one essential part of the present embodiment.

The injector base body 100 is provided with a high-pressure GF introduction flow passage 362 and a high-pressure LF introduction flow passage 250 formed therein. The gaseous fuel GF is introduced into the high-pressure GF introduction flow passage 362 and the liquid fuel LF is introduced into the high-pressure LF introduction flow passage 250.

The flow passage switching valve 400 is constructed of a two-position three-way valve in which a first port P1 and a third port P3 are communicated as a first flow passage at a switching valve position 1, and a second port P2 and a third port P3 are communicated as a second flow passage at a switching valve position 2.

The high-pressure GF introduction flow passage 362 is connected to the first port P1 of the flow passage switching valve 400. On the other hand, the high-pressure LF introduction flow passage 250 branches into an LF supply passage 260 and a backpressure flow passage 270. Further, the LF supply passage 260 is connected through an LF flow passage connecting portion 261 and an LF flow passage 262 to the second port P2 of the flow passage switching valve 400. The backpressure flow passage 270 is connected through a throttle passage 131 to a backpressure control chamber 133.

The third port P3 of the flow passage switching valve 400 is connected through the passages 401, 402, 403 and 404 to the fuel supply passage 405. The fuel supply passage 405 is further connected through a feed passage 407 to be described later to a fuel chamber 408.

The nozzle portion 11 includes a nozzle base body 110 being a bottomed cylindrical member, a retaining nut portion 130 for fitting the nozzle base body 110 to the injector base body 100, and a needle 120 slidably retained inside the nozzle base body 110. In the nozzle base body 110, a longitudinal hole extending in an axial direction is formed in a center thereof as a needle sliding hole 111 and a needle sliding portion 121 of the needle 120 axially extending is slidably retained. Nozzle holes 115 are formed at a bottom portion 114 of the nozzle base body 110, which are opened and closed by the seating and lifting of a needle valve portion 124 formed at a tip end of the needle 120.

Inside the nozzle base body 110, a circular space as the fuel chamber 408 is formed between a periphery of a needle axis portion 123 of the needle 120 and an inner wall of the nozzle base body 110 and a sack chamber 116 is formed below the fuel chamber 408. The nozzle holes 115 are formed so as to penetrate through the bottom portion 114 forming the sack chamber 116.

The high-pressure gaseous fuel feed passage 407 is formed in the nozzle base body 110. The feed passage 407 has one end opened to the fuel chamber 408 and the other end opened to an upper end surface of the nozzle base body 110 and also communicated to the fuel supply passage 405. A lubricating oil supply passage 406 is formed in the nozzle base body 110. The lubricating oil supply passage 406 has one end opened to the needle sliding hole 111 and the other end opened to the upper end surface of the nozzle base body 110 and also communicated to the fuel supply passage 405.

The fuel chamber 408 formed at the half-lower part of the nozzle base body 110 is formed so as to increase a volume of fuel which can be accommodated in the fuel chamber 408 by reducing an outer diameter of the needle axis portion 123 and enlarging an inner diameter of the nozzle base body 110. More specially, the inner diameter of the fuel chamber 408 is larger than the inner diameter of the needle sliding hole 1111 and the outer diameter of the needle axis portion 123 is smaller than the needle sliding portion 121.

The needle valve portion 124 having a generally inverted conical surface is formed at a tip end of the needle 120 to be in close contact with a seat inner surface 113 of the nozzle base body 110 facing a valve seat surface 125. A control piston 126 moving together with the needle 120 is arranged in a base side of the needle 120 to be capable of sliding in a control piston sliding hole 101 formed in the injector base body 100. In the same way as the needle sliding portion 121, multiple circular groove portions 212 are formed in an outer periphery of a sliding portion 127 of the control piston 126 and the gaseous fuel GF remains in a circular groove portion 128 to be capable of lubricating a sliding portion 211.

The backpressure control valve portion 15 is arranged at a back side of the control piston 126 so as to close the control piston sliding hole 101. The backpressure control chamber 133 is formed by a space defined between an upper end surface of the control piston 126, an inner wall of the control piston sliding hole 101 above the upper end surface, and a lower end surface of the backpressure control valve portion 15. High-pressure liquid fuel LF is introduced through the throttle passage 131 to the backpressure control chamber 133, and a pressure of the high-pressure liquid fuel LF acts on the back surface of the control piston 126 in a valve-closing direction of the needle valve portion 124.

The backpressure control valve portion 15 is constructed of a control valve body 150 and a release passage 151, and the control valve body 150 is manipulated to be opened and closed by the actuator 14. The backpressure control chamber 133 is provided with an outlet passage 132 formed therein, and the outlet passage 132 is opened and closed by the control valve body 150. A pressure in a valve-closing direction by the liquid fuel in the backpressure control chamber 133 and a pressure in a valve-opening direction through the needle 120 by the fuel in the fuel chamber 408 exert on the control piston 126. Further, the control piston 126 is biased in a valve-closing direction by a return spring arranged in a spring chamber formed on a middle outer periphery of the control piston 126. In consequence, the control piston 126 and the needle 120 move upward and downward by increasing and decreasing a pressure of the liquid fuel LF in the backpressure control chamber 133. The liquid fuel LF as a pressure transmission medium generating a counterbalance pressure is introduced to a space defined by the inner wall of the nozzle base body (injector base body) 100. The nozzle base body 100 is formed around the circumference of the piston axis portion of the control piston 126.

The actuator 14 in the present embodiment is constructed of a cylindrical solenoid 140, an armature 142 having a T-shaped cross section facing a lower end surface of the solenoid 140 and a biasing spring 141 provided in the cylinder of the solenoid 140. Power supply to the actuator 14 is controlled by the ECU 40 and the EDU 41. At non-power supplying, the armature 142 is biased in a valve-closing direction by the biasing spring 141 and the control backpressure chamber outlet passage 132 is closed by the control valve body 150 fixed to a tip end of the armature 142. On the other hand, at power supplying, the solenoid 140 is energized to pull up the armature 142 against a spring force of the biasing spring 141, thus opening the control backpressure chamber outlet passage 132. The liquid fuel LF is introduced into spaces at upper and lower sides of the armature 142 communicated with a release passage 281 for applying the counterbalance pressure to the armature 142.

The ECU 40 obtains an operating condition of an engine by calculating based upon input signals such as an engine rotation speed Ne, a crank angle, a GF pressure Ph, an LF pressure Pc, and a cooling water temperature inputted from an engine rotation detector, a G sensor, a GF pressure sensor 33, an LF pressure sensor 26, a cooling water temperature sensor and the like (not shown) to transmit a manipulate signal of the fuel injection valve 10 to the EDU 41. The actuator 14 is manipulated according to the drive current supplied from the EDU 41 to the actuator 14. When power is supplied to the solenoid 140 according to a command from the ECU 40, the solenoid 140 is energized to pull up the armature 142 against the spring force of the biasing spring 141. Subsequently, the control valve body 150 is pulled up in association with the above movement to open the outlet passage 132 of the backpressure control chamber 133, so that the gaseous fuel GF in the backpressure control chamber 133 flows out through the outlet passage 132 from release passages 281 and 280. Subsequently, a pressure in the backpressure control chamber 133 is lowered to lift up the control piston 126 and the needle 120. The nozzle holes 115 are opened to inject high-pressure fuel from the fuel chamber 408.

At this time, the ECU 40 performs switching-control of the flow passage switching valve 400 housed in the fuel injection valve 10 so as to appropriately select and inject fuel to be injected from the fuel injection valve 10 into the internal combustion engine from the gaseous fuel GF and the liquid fuel LF, based upon an operating state and a fuel remaining quantity.

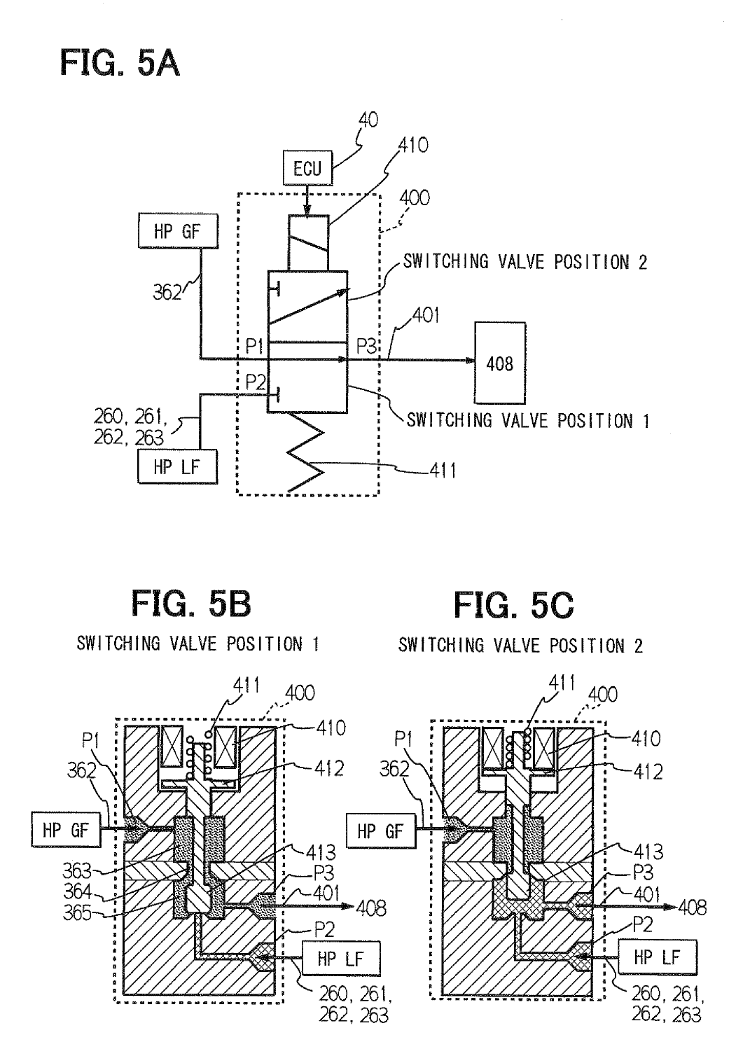

The flow passage switching valve 400, which is one essential element of the present embodiment, will be in detail explained with reference to FIGS. 5A, 5B and 5C. FIG. 5A is a schematic diagram showing the flow passage switching valve 400. FIG. 5B is a cross sectional diagram showing the flow passage switching valve 400 at the switching valve position (switching position) 1 forming a first passage. FIG. 5C is a cross sectional diagram showing the flow passage switching valve 400 at the switching valve position 2 forming a second passage. At a switching valve position 1, a first port P1 and a third port P3 are communicated to define a first passage, and the high-pressure GF introduction flow passage 362 is communicated with the fuel chamber 408. At a second switching valve position, a second port P2 and a third port P3 are communicated to define a second passage, and the high-pressure LF supply passage 260 is communicated with the fuel chamber 408.

The flow passage switching valve 400 according to the present embodiment is constructed of a two-position and three-direction valve as shown in FIG. 5A. The high-pressure gaseous fuel GF is supplied to the first port P1 and the high-pressure liquid fuel LF is supplied to the second port P2. As shown in FIG. 5B, in a case of the switching valve position 1 where the solenoid 410 is not energized, the spring 411 biases the valve body 413 in a valve-closing direction of the second port P2. As a result, the first port P1 is communicated with the third port P3 through a switching valve chamber 363, a communicating passage 364, and a switching valve chamber 365, whereby the high-pressure gaseous fuel GF is supplied to the fuel chamber 408. As shown in FIG. 5C, in a case of the switching valve position 2 where the solenoid 410 is energized, the armature 412 is pulled up to the solenoid 410 against the spring force of the spring 411. The communicating passage 364 is blocked by the valve body 413, and the second port P2 is communicated with the third port P3 through the switching valve chamber 365 to supply the high-pressure liquid fuel LF to the fuel chamber 408. When the switching valve position 1 and the switching valve position 2 are switched according to a power supply command from the ECU 40, the first passage and the second passage are switched to alter the fuel supplied to the fuel chamber 408.

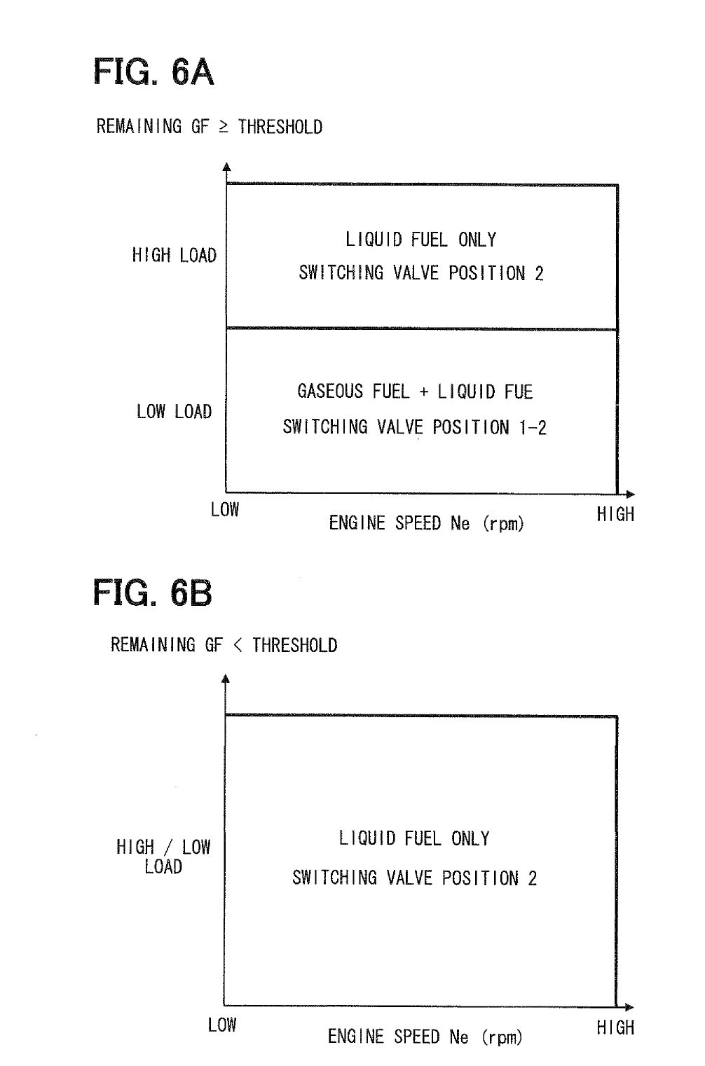

FIGS. 6A and 6B explain a switching condition between the gaseous fuel GF the liquid fuel LF in the fuel injection device 1. As shown in FIG. 6A, when a remaining quantity of the gaseous fuel GF is greater than or equal to a predetermined value (threshold), for example, a pressure Ph in a GF tank is ½ or greater of full-charge pressure P0, the switching valve position 1 and the switching valve position 2 of the flow passage switching valve 400 are switched as needed in a low-load region to perform an injection control of injecting both of the gaseous fuel GF and the liquid fuel LF. Alternatively, the flow passage switching valve 400 is fixed to the switching valve position 2 in a high-load region to perform injection control of only the liquid fuel LF.

As shown in FIG. 6B, when the remaining quantity of the gaseous fuel GF is less than a predetermined value, for example, the pressure Ph in the GF tank is less than ½ of full-charge pressure P0, the flow passage switching valve 400 is fixed to the switching, valve position 2 in an all-load region (high/low load) to perform injection control of only the liquid fuel LF Such a control achieves reduction in emissions in the combustion exhaust gas by combustion of the gaseous fuel GF in a low-load region where harmful emissions in the combustion exhaust gas increase in combustion by only the liquid fuel LF, while the remaining quantity of the gaseous fuel GF is sufficiently large. In the high-load region where harmful emissions in the combustion exhaust gas are relatively small in quantity even in combustion by only the liquid fuel LF, the combustion is performed by only the liquid fuel LF, whereby consumption of the gaseous fuel GF can be reduced. In a case where a remaining quantity of the gaseous fuel GF is less than a predetermined value, an engine operation can continue urgently and temporarily by combustion of only the liquid fuel LF in an all-load region (high/low load).

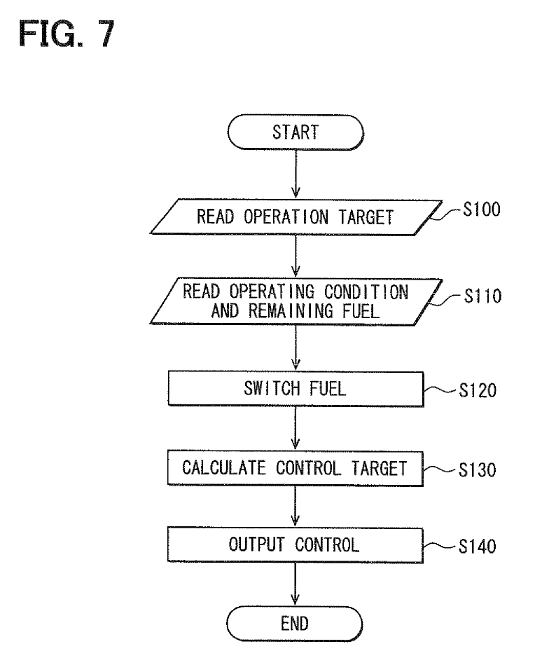

Hereinafter, the switching control between gaseous fuel GF and liquid fuel LF used in the present embodiment will be explained. First, a main routine of the switching control will be explained with reference to FIG. 7. At S100, an operation target is read in. Next, at S110, an operating state of the engine is read in and at the same time, a remaining quantity of each of the gaseous fuel GF and the liquid fuel LF is read in. At S120, an optimal fuel selection is performed in accordance with the operation target, the operating state, and the fuel remaining quantity to determine a switching valve position of the flow passage switching valve 400, thus performing the fuel switching control. At S130, a control target value is calculated and set in accordance with the operation target, the operating state, the fuel remaining quantity, and the selection fuel. More specially, in a case of injecting the gaseous fuel GF as a control object, injection timing T_{GF} and an injection quantity Q_{GF} are determined. In a case of injecting the liquid fuel LF as a control object, an injection pressure Pc, injection timing T_{LF} and an injection quantity Q_{LF} are determined. At S140, the output to the actuator 14 is controlled in accordance with the control target value to manipulate the actuator 14 in a predetermined condition, and thus a predetermined fuel injection from the fuel injection valve 10 is performed. In the main routine, the gaseous fuel GF is basically injected, and the fuel selection and the selection of the injection method, which will be described below, are performed in accordance with the operating state.

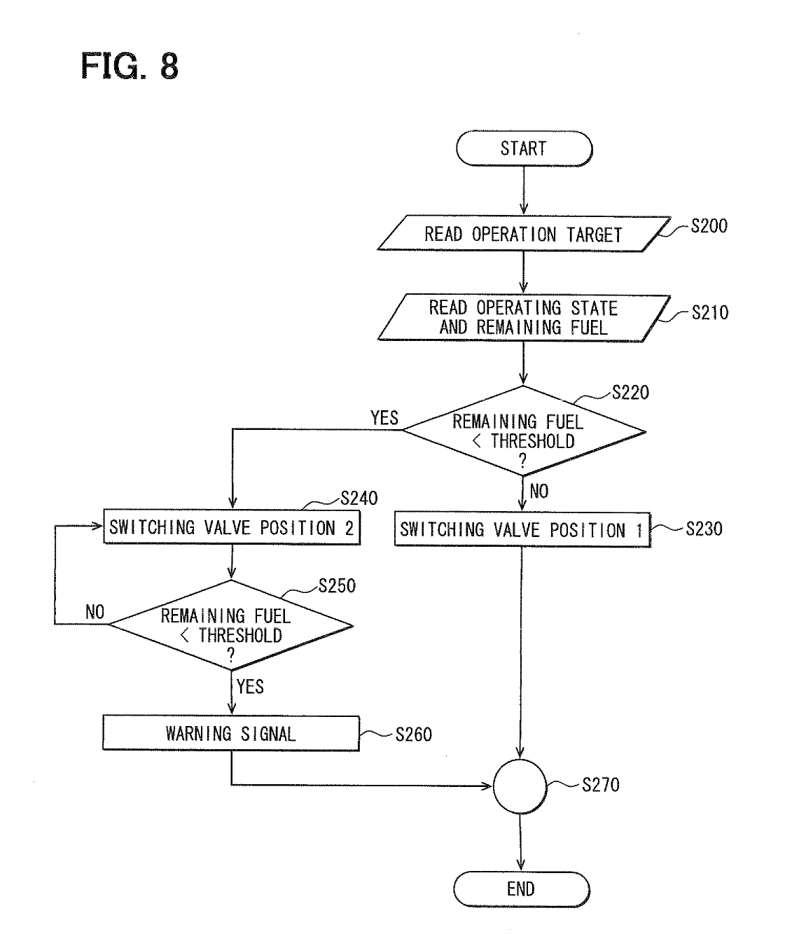

Next, a fuel selection routine will be explained with reference to FIG. 8. At S200, an operation target is read in. Next, at S210, an operating state of the engine is read in and at the same time, a remaining quantity of each of the gaseous fuel GF and the liquid fuel LF is read in. In a case where a remaining quantity of the gaseous fuel GF is greater than or equal to a predetermined value, the process goes to S230, wherein the flow passage switching valve 400 is set to the switching valve position 1 to perform injection of a predetermined quantity of the gaseous fuel GF according to the main routine. In a case where a remaining quantity of the gaseous fuel GF is less than a predetermined value (threshold) by consumption of the gaseous fuel GF, the process goes to S240, wherein the flow passage switching valve 400 is set to the switching valve position 2 to perform injection of only the liquid fuel LF. Further, in a case where a remaining quantity of the liquid fuel LF is less than a predetermined value (threshold), the process goes to S260, wherein a warning signal is outputted to make a driver pay attention.

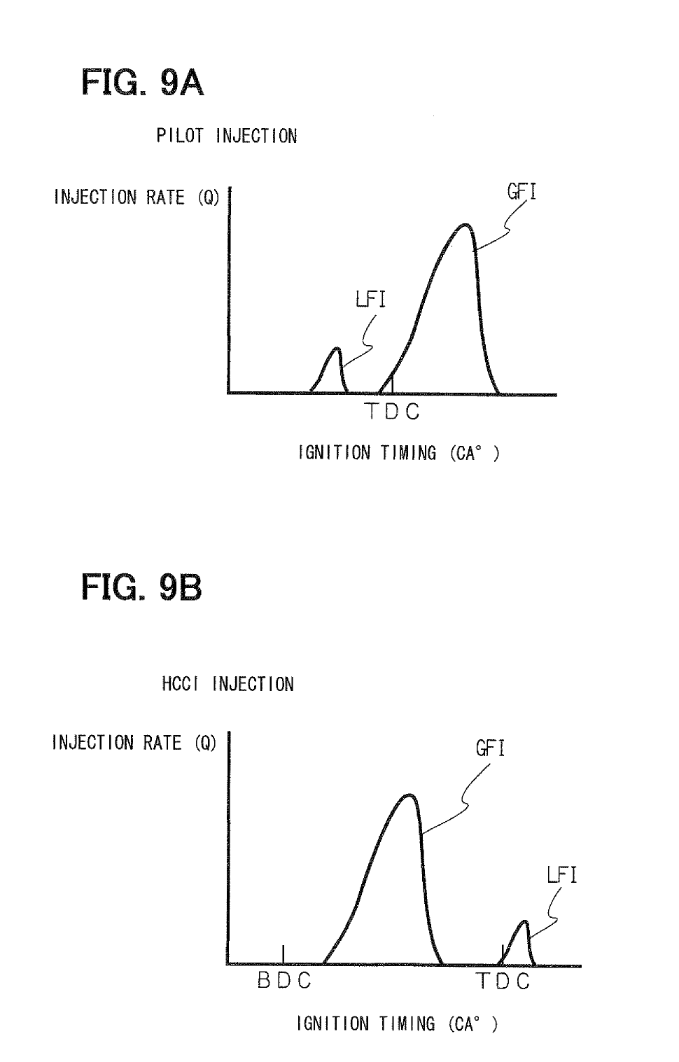

A pilot injection of switching the gaseous fuel GF and the liquid fuel LF as needed and an HCCI injection will be explained with reference to FIGS. 9A to 11. As shown in FIG. 9A, the flow passage switching valve 400 may be controlled so that in a pilot injection, the liquid fuel LF is injected by a small quantity beforehand (shown by LFI in the drawing) as a spark source to ignition of the gaseous fuel GF having low ignitability, and then, the gaseous fuel GF is injected (shown by GFI in the drawing). As shown in FIG. 5B, the flow passage switching valve 400 may be controlled so that in an HCCI injection, the gaseous fuel GF is injected into a cylinder beforehand (shown by GFI in the drawing) to form a uniform mixture of air and fuel and thereafter, the liquid fuel LF is injected by a small quantity (shown by LFI in the drawing) as a spark source.

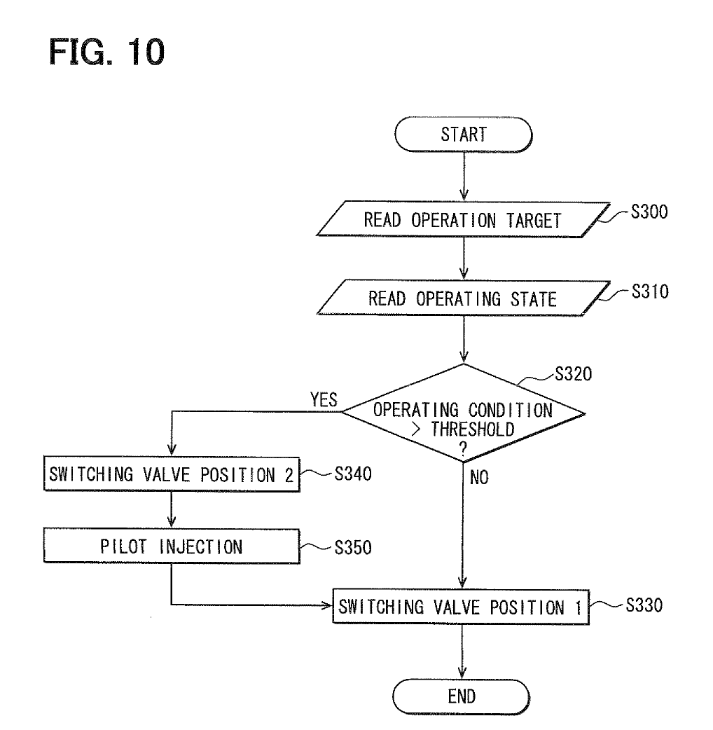

A pilot injection control routine will be explained with reference to FIG. 10. In the pilot injection control routine, at S300, an operation target is read in. Next, at S310, an operating state of the engine is read in. At S320, an operating condition is determined. When the operating condition is greater than or equal to a predetermined value (threshold), for example, the engine operation is in the high-load region, and an engine rotation speed Ne is high. In addition, the period between a fuel injection start and a point, in which the piston is at the TDC, is shortened. Thus, the fuel injection quantity is required to be increased, and the injection time is lengthened. Accordingly, in a high-rotation-speed region and in the high-load region, the process goes to S340 for enhancing ignitability, wherein the flow passage switching valve 400 is set to the switching valve position 2. At S350, a predetermined quantity of the liquid fuel LF is injected as pilot injection at a predetermined timing, and then the process goes back to a main routine, wherein a predetermined quantity of the gaseous fuel GF is supposed to be injected. On the other hand, when an operating condition is less than the predetermined value, for example, the engine operation is in the low-rotation-speed region, and the process goes to S330, wherein the flow passage switching valve 400 is set to the switching valve position 1. Thus, the process goes back to the main routine, wherein a predetermined quantity of the gaseous fuel GF is supposed to be injected.

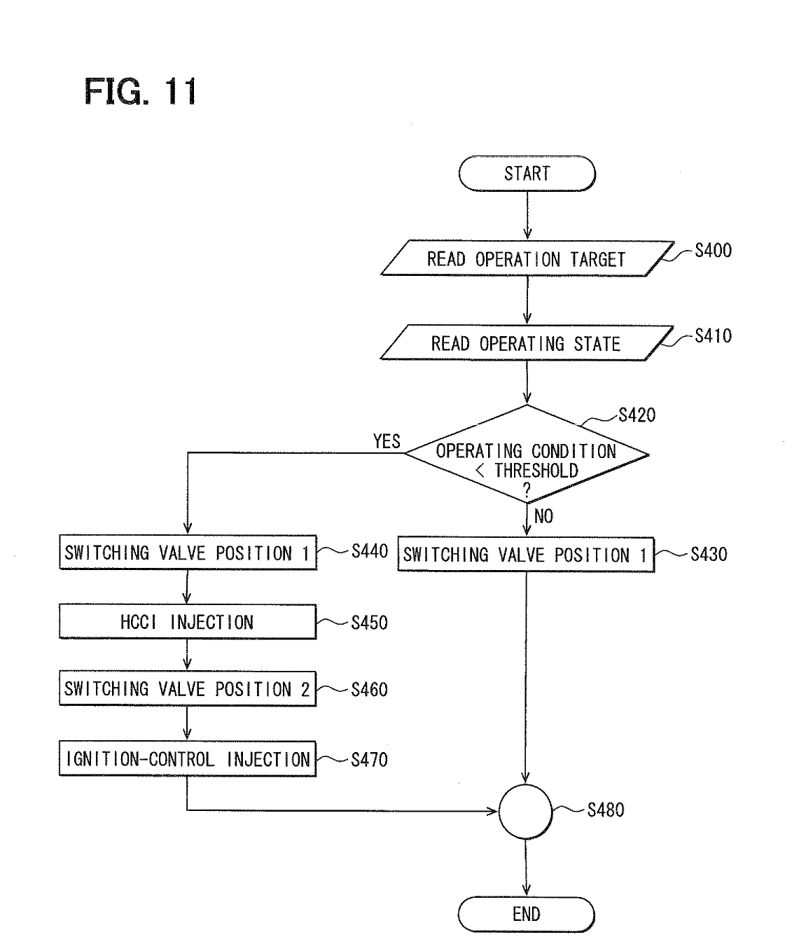

An HCCI injection control routine will be explained with reference to FIG. 11. At S400, an operation target is read in. Next, at S410, an operating state of an engine is read in. At S420, an operating condition is determined. When the operating condition is less than a predetermined value (threshold), for example, the engine operation is in the low-rotation-speed region and the low-load region. In this case, the process goes to S440, wherein the flow passage switching valve 400 is set to the switching valve position 1. At S450, a predetermined quantity of the gaseous fuel GF is injected as HCCI injection at a predetermined timing to uniformly mix the fuel with compressed air. Next, at S460, the flow passage switching valve 400 is set to the switching valve position 2 and at S470, a predetermined quantity of the liquid fuel LF as a spark source is injected at a predetermined timing to control the ignition. On the other hand, when the operating condition is greater than or equal to the predetermined value, for example, the engine operation is in a high-rotation-speed region and a high-load region. In this case, the process goes to S430, wherein the flow passage switching valve 400 is set to the switching valve position 1. Thus, the process goes back to a main routine, wherein a predetermined quantity of the gaseous fuel GF is supposed to be injected.

### Second Embodiment

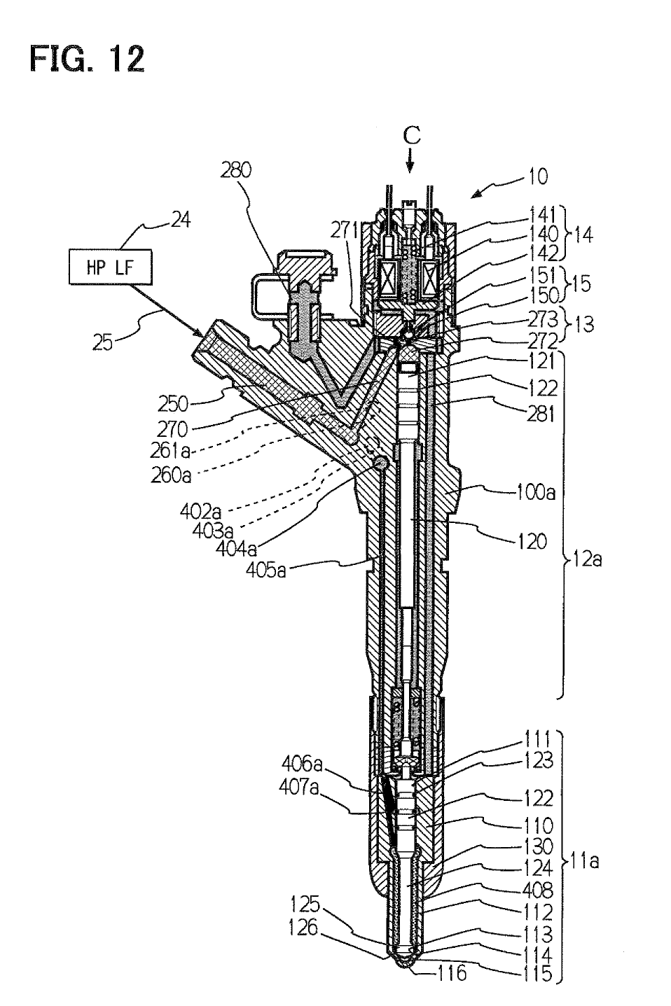

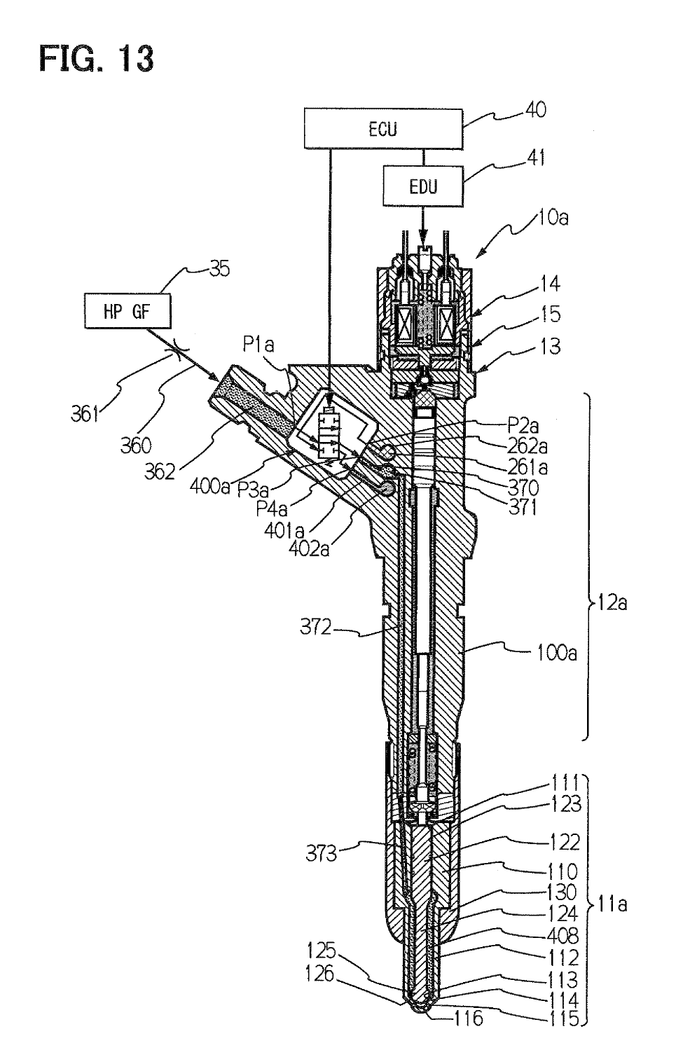

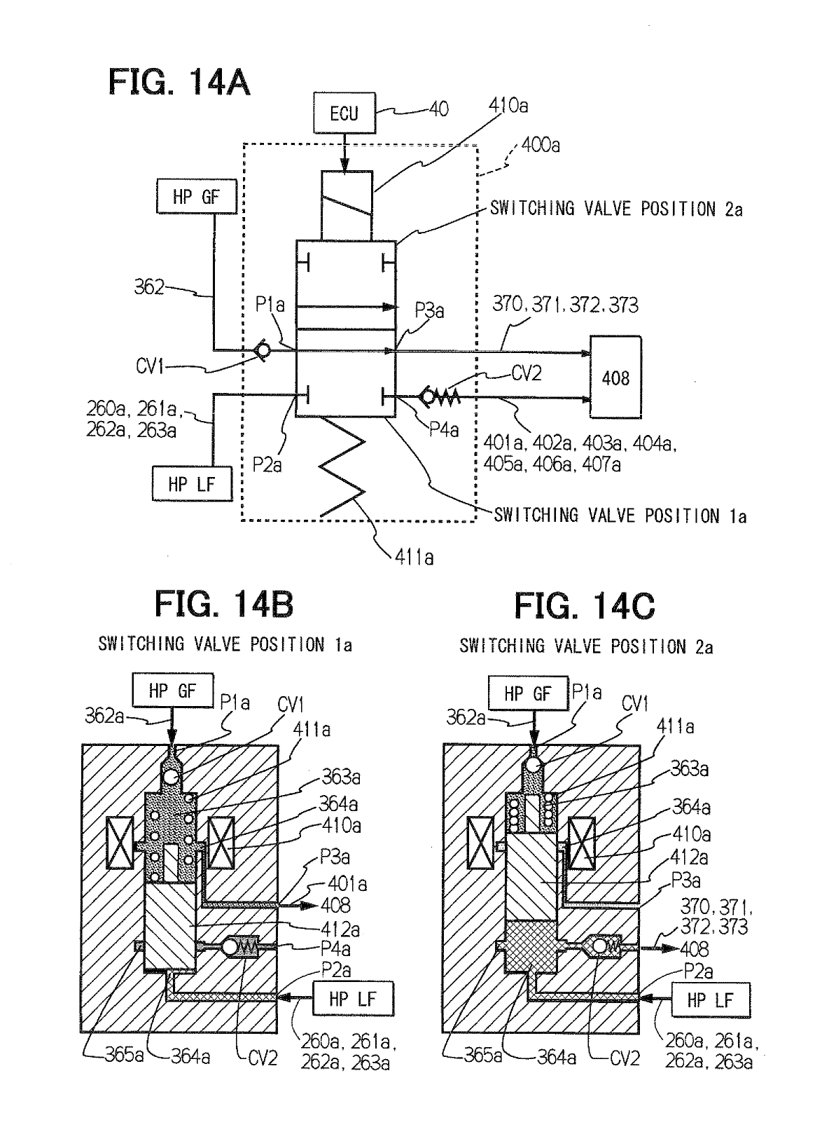

FIG. 12 to FIG. 14C each shows a fuel injection valve 10a using a passage switching valve 400a according to a second embodiment. Components substantially identical to those in the above embodiment are referred to as identical numerals and description thereof is omitted. FIGS. 12 and 13 are longitudinal cross sections each showing the fuel injection valve 10a according to the present embodiment. FIG. 14A is a schematic diagram showing the flow passage switching valve 400a according to the present embodiment. FIG. 14B is a partial cross section showing the flow passage switching valve 400a at a switching valve position 1. FIG. 14C is a partial cross section showing the flow passage switching valve 400a at a switching valve position 2.

The present embodiment substantially differs in the following construction from the above first embodiment. A two-position and four-way valve shown in FIG. 14A is used as the flow passage switching valve 400a. A high-pressure GF passage (GF introduction flow passage) 362 is connected through a first one-way valve CV1 to a first port P1a of the flow passage switching valve 400a. A high-pressure LF passage 263a is connected to a second port P2a. A third port 3a is connected through GF passages 370, 371, 372 and 373 to the fuel chamber 408. A fourth port P4a is connected through a second one-way valve CV2 and LF passages 401a, 402a, 403a, 404a, 405a, 406a and 407a to the fuel chamber 408.

The flow passage switching valve 400a is constructed of a solenoid 410a, a piston 412a, a spring 411a, valve chambers 363a and 364a, circular grooves 364a and 365a, the first one-way valve CV1, the second one-way valve CV2, the first port P1a, the second port P2a, the third port P3a, and the fourth port P4a, In the flow passage switching valve 400a, at a first switching valve position, the first port P1a and the third port P3a are communicated as a first passage and at a second switching valve position, the second port P2a and the fourth port P4a are communicated as a second passage.

When the gaseous fuel GF introduced from the first port P1a maintains a pressure Ph greater than or equal to a valve-opening pressure of the first one-way valve CV1, the gaseous fuel GF opens the first one-way valve CV1 to be introduced into the valve chamber 363a, thus pressing the back surface of the piston 412a. When the pressure of the gaseous fuel GF and the biasing force of the spring 411a are higher than a pressure of the liquid fuel LF introduced from the second port P2a, the piston 412a closes the second port P2a and the circular groove 365a, and opens the circular groove 364a. The circular groove 364a is communicated with the third port P3a, and the gaseous fuel GF is drained from the third port P3a and introduced through the fuel passages 401a to 407a into the fuel chamber 408.

When a pressure of the gaseous fuel GF exerting on the back surface of the piston 412a biased by the spring 411a is smaller than a pressure of the liquid fuel LF or when the solenoid 410a is energized, the piston 412a is pulled up to the side of the solenoid 410a. Thereby, the circular groove 364a is closed, and also the first port P1a is closed by the first one-way valve CV1. In addition, the circular groove 365a is opened, and the second port P2a is communicated with the fourth port P4a through the valve chamber 364a and the second one-way valve CV2. When the pressure of the liquid fuel LF is greater than or equal to a valve-opening pressure of the second one-way valve CV2, the second one-way valve CV2 is opened and the gaseous fuel GF is introduced into the fuel chamber 408 through LF passages 307 to 373.

According to the present embodiment, since the gaseous fuel GF and the liquid fuel LF supplied to the fuel chamber 408 can be switched at an arbitrary timing by the control of the solenoid 410a, the effect similar to that of the above embodiment can be acquired. Further, reverse flow of the fuel can be restricted by the effect of each of the first one-way valve CV1 and the second one-way valve CV2. Since the GF passages 401a to 407a and the LF passages 370 to 373 are separately connected to the fuel chamber 408, the liquid fuel LF may not flow back to the GF passages 401a to 407a or the gaseous fuel GF does not flow back to the LF passages 370 to 373. Therefore, at injecting the gaseous fuel GF, the gaseous fuel GF is not injected in a state of mixing with the liquid fuel LF. Alternatively, at injecting the liquid fuel LF, the liquid fuel LF is not injected in a state of mixing with the gaseous fuel GF. Thus, fuel injection can be performed with higher accuracy.

In place of the flow passage switching valve 400a used in the present embodiment, the piston 412a may be moved by only a pressure difference between the gaseous fuel GF and the liquid fuel LF without the solenoid 410a. In consequence, when a pressure of the gaseous fuel GF is less than a predetermined value, it is possible to perform the injection using only the liquid fuel LF.

The present invention is not limited to the aforementioned embodiments, but modifications may be made as needed within the spirit of the present invention in which the first passage and the second passage are selected by switching a valve position of the flow passage switching valve so as to switch the fuel introduced into the fuel chamber. For example, the actuator 14 used in the first embodiment of the present invention may be replaced by a piezoelectric actuator using a piezoelectric element. The aforementioned embodiments are explained with reference to the example in which the gaseous fuel is used as the high-pressure gaseous fuel and the liquid fuel is used as the high-pressure liquid fuel, but a liquefied petroleum gas may be used as the high-pressure gaseous fuel and liquid fuel may be used as the high-pressure liquid fuel or a low-cetane number fuel may be used as the high-pressure gaseous fuel and a high-cetane number fuel may be used as the high-pressure liquid fuel. Theses constructions can acquire the same effect.

The above structures of the embodiments can be combined as appropriate.

The above processings such as calculations and determinations are not limited being executed by the ECU and the EDU. The control unit may have various structures including the ECU and the EDU shown as an example.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

The above embodiment may be applied to a method for manipulating the fuel injector 1, the method may including obtaining the operation target of the engine, obtaining the operating condition of the engine, obtaining at least one of the remaining quantity of gaseous fuel and the remaining quantity of liquid fuel, selecting the fuel, and controlling manipulation of the fuel injector, for example.

Various modifications and alternations may be diversely made to the above embodiments without departing from the spirit of the present invention.

What is claimed is:

1. A fuel injector configured to inject gaseous fuel into a combustion chamber of an engine by using liquid fuel as a pressure transmission medium to open and close a nozzle hole, the fuel injector comprising:
a nozzle portion having a fuel chamber and a tip end, which defines the nozzle hole;
a first passage configured to communicate the fuel chamber with a gaseous fuel passage to introduce gaseous fuel;
a second passage configured to communicate the fuel chamber with a liquid fuel passage to introduce liquid fuel; and
a passage switching valve configured to switch the first passage and the second passage.

2. The fuel injector according to claim 1, wherein the passage switching valve includes a pressure differential valve, which is operated in accordance with a difference in pressure between gaseous fuel and liquid fuel.

3. The fuel injector according to claim 1, further comprising:
a solenoid configured to operate the passage switching valve when being energized.

4. The fuel injector according to claim 1, further comprising:
a needle including a valve portion configured to open and close the nozzle hole;
a base body being generally in a cylindrical shape and slidably holding the needle;
a backpressure chamber configured to apply a pressure in a valve-closing direction to the needle by using liquid fuel as the pressure transmission medium;
a backpressure control valve configured to open and close an outlet passage of the backpressure chamber; and
an actuator configured to manipulate the backpressure control valve,
wherein at least one of gaseous fuel and liquid fuel in the fuel chamber is selectively introduced in response to a switching position of the passage switching valve so as to transmit and apply pressure of the at least one of gaseous fuel and liquid fuel to the needle in an opening direction.

5. A fuel injection device comprising;
the fuel injector according to claim 1; and
an electronic control unit for controlling the fuel injector,
wherein the electronic control unit includes:
operation target obtaining means for obtaining an operation target of the engine;
operating condition obtaining means for obtaining an operating condition of the engine;
remaining quantity obtaining means for obtaining at least one of a remaining quantity of gaseous fuel and a remaining quantity of liquid fuel;
fuel selection means for selecting the fuel; and
manipulation control means for controlling manipulation of the fuel injector.

6. The fuel injection device according to claim 5, wherein the fuel selection means sets the passage switching valve to select the second passage so as to introduce liquid fuel into the fuel chamber, when the remaining quantity of gaseous fuel is less than a predetermined value.

7. The fuel injection device according to claim 5, wherein the fuel selection means sets the passage switching valve to select the first passage, after the fuel selection means sets the passage switching valve to select the second passage to inject a predetermined quantity of liquid fuel prior to injection of gaseous fuel.

8. The fuel injection device according to claim 5, wherein the fuel selection means sets the passage switching valve to select the second passage, after the fuel selection means sets the passage switching valve to select the first passage so as to inject a predetermined quantity of liquid fuel at an ignition timing, subsequent to injecting gaseous fuel.
